(19) United States
(12) Patent Application Publication
(10) Pub. No.: US 2012/0115974 A1
(43) Pub. Date: May 10, 2012

(54) PROCESS FOR OBTAINING HYDROPHILIC MEMBRANES FROM POLY(N-VINYL-2-PYRROLIDONE) PVP

(75) Inventors: Leila Figueiredo De Miranda, Sao Paulo-Sp (BR); Mauro Cesar Terence, Sao Paulo-Sp (BR); Sonia Braunstein Faldini, Sao Paulo-Sp (BR)

(73) Assignee: Instituto Presbiteriano Mackenzie, Sao Paulo-Sp (BR)

(21) Appl. No.: 13/264,050

(22) PCT Filed: Apr. 16, 2010
(86) PCT No.: PCT/BR2010/000128

§ 371 Date: Jan. 26, 2012

(30) Foreign Application Priority Data
Apr. 16, 2009 (BR) PI0900867-5

(51) Int. Cl. C08J 3/28; C08K 13/02; C08L 39/06

(52) U.S. Cl. 522/72

(57) ABSTRACT

The process comprises the steps of: obtaining diethyl maleate from maleic anhydride; purifying the diethyl maleate and submitting it to two or more distillation steps, for removing remaining contaminants; mixing a load of poly(N-vinyl-2-pyrrolidone)-PVP with a load of the distilled diethyl maleate, forming a mixture having a concentration predetermined as a function of the membrane to be obtained; hot treating the mixture so as to graft the diethyl maleate to the poly(N-vinyl-2-pyrrolidone)-PVP; adding to the heated mixture, the additional components defined by poly(ethylene glycol)-PEG, agar and water, until reaching 100% by weight of a hydrophilic composition; cooling the hydrophilic composition to the ambient temperature; and submitting the cooled hydrophilic composition to electron beam irradiation, obtaining a hydrogel.

### FIELD OF THE INVENTION

The present invention refers to a process for obtaining hydrophilic membranes of the type used in topical bandages, from poly(N-vinyl-2-pyrrolidone) (PVP).

### BACKGROUND OF THE INVENTION

Polymers are macromolecules formed by the union of a large number of smaller molecules (tens, thousands, or tens of thousands) called monomers, which are found in nature as organic or inorganic compounds or which can also be synthesized by man. Many of the materials in the living organisms are organic polymers, such as proteins, nucleic acids, cellulose, lignin and natural resins of plants. These natural materials alone already confer importance to the polymers. However, said importance is increased due to the wide range of applications of the synthetic polymers, that is, those artificially produced. Polymeric materials are used in the domestic and medical fields, as well as in the automotive, civil engineering, aerospace, prosthetic, chemical and biochemical industries.

The importance of the polymeric materials can be noted by the increase of their production and market share along the last decades. Since the 1950's, the area of the polymeric materials is the one that has presented the greatest growth curve. The use of these materials became very popular due to their properties, which comprise chemical, thermal and mechanical resistance, and low density, allied to competitive prices.

The reaction between the monomers for the formation of polymers (known as polymerization), can be carried out in chain (addition reaction) or in steps (condensation reaction). The polymerization reactions require a series of conditions to achieve good results with the formed products, and it is necessary to know the physical-chemical characteristics of the material to be produced, in order to evaluate which is the best technique to be used.

The emulsion polymerization uses water (since aqueous solutions, if properly maintained, are stable), water-insoluble monomer, water-soluble initiator and emulsifier. The emulsifier is a very important factor in the emulsion polymerization, mainly for determining the size and distribution of the resulting latex particles. The reaction occurs in a heterogeneous medium, being initiated by the free radicals generated by decomposition of the initiator and which react with the monomer, starting the polymerization reaction, whose reaction rate is relatively high. The free radicals are formed in the aqueous phase and migrate to the organic phase. The diameter of the polymer particles ranges from 0.05 μm to 0.2 μm.

The advantages of said polymerization technique are: high polymerization rate, high heat removing capacity, low viscosity of the reactional medium, formation of high molecular-mass polymers and minimization of environmental problems. However, such technique presents the following disadvantages: difficulty in completely removing the residues, need for a water-soluble initiator and need for a coagulant for precipitation of the polymer.

The homopolymer PVP (POLY(N-VINYL-2-PYRROLIDONE)) is obtained by polymerization, via radicals, by chemical initiation, of the cyclic amide N-vinyl-2-pyrrolidone, being highly polar and having amphoteric characteristics. These characteristics are indispensable in a hydrogel.

The PVP, as a function of its amphipathic structural characteristic, having hydrophobic methylene groups and hydrophilic amide groups, is soluble in many organic solvents and in water, in which it forms hydrogen bondings in the amide groups. The PVP in aqueous solution, under the action of free radicals or under ionizing radiation, in this last case suffering influence mainly from the action of the OH. radicals, the influence of the electrons and H. radicals (species produced in the water radiolysis) being negligible. The PVP can be stored under normal conditions, without presenting structural modifications, being stable up to 130° C. by short time intervals. The PVP used herein is from GAF CHEMICALS CORPORATION (trade name: PLASDONE K-90 Povidone).

The emulsion polymerization is used for obtaining the most varied types of products which can be consumed directly in the form of emulsion, as the ones incorporated in solid substrates for drug release and in the hydrogels employed for obtaining hydrophilic membranes used in the production of topical bandages.

Hydrogels can be defined as a polymeric material which, although being insoluble in water, can absorb it and retain a significant fraction in its structure. The material which forms the hydrogel-based hydrophilic membranes has the above characteristics and is composed by cross-linked (reticulated) and/or interlaced polymeric systems, or by a grafted copolymer, one of them forming the main skeleton and other forming a branch.

In the two types of polymeric system, one of the components is a hydrophilic polymer which, after cross-linked, becomes insoluble in water, due to the existence of a tridimensional net linking its chains, and the other component is the water retained in its structure.

These systems can expand by absorbing water or polar substances, until reaching the equilibrium state, and keep their original form and function. This is an essential property presented by the hydrogels, similar to that presented by the organic bodies, which makes them become interfaces that are biocompatible with a broad variety of applications. Besides the wettability, they present permeability to the biologically active substances with low molar masses, being used in bandages in direct contact with the living tissue, that is, used as covers for injuries caused by burns, vascular prostheses, artificial cartilaginous membranes, membranes for hemodialysis, among other applications. The hydrophilic membranes, when used for cicatrization of trophic ulcers and burns, present the following advantages: they reduce the trauma during the change of bandages (dispensing the use of adhesives); they are impermeable to bacteria, flexible, non-toxic, hypoallergenic, transparent (allow optimizing the number of changes); they enable the topic application of medication through the membrane.

The hydrogel-based hydrophilic membrane can be cross-linked by means of chemical processes or by irradiation. The use of ionizing radiation for obtaining hydrogels has the following advantages: absence of chemical initiators; cross-linking process with simultaneous sterilization which can be made in the package to be used; possibility of cross-linking at low temperatures; the initiation and termination of the chemical reactions are carried out by introducing or removing the material into/from the radiation area; physical and/or chemical properties required by the end product can be obtained by adjusting the irradiation conditions (radiation type, intensity and time; modification of the initial batch).

In the hydrogel formation process by radiation, there are obtained products with higher mechanical properties and lower toxicity, since the peroxides, generally used in the processes by chemical initiation, are highly toxic and most react at a temperature of approximately 70° C., reducing the mechanical properties. This process essentially consists in cross-linking the polymeric material in the presence of water and other components by direct or indirect interaction with the ionizing radiation.

The PVP-based hydrophilic membranes are known by their chemical inertia, high hydrophilicity and adequate biomedical properties.

Although their excellent biomedical properties have been confirmed for clinical practice, it has been observed that the handling of such materials can become difficult due to the attention needed to prevent mechanical damages during application thereof.

Nevertheless, the polymers obtained with the known techniques can present a low degree of purity, resulting in a hydrophilic membrane with non-satisfactory properties.

Moreover, the hydrophilic membranes obtained as described above present a limitation of application regarding the size of the bandages to which they are applied, as is the case of burns in large extensions of the body.

### SUMMARY OF THE INVENTION

In face of the inconveniences commented above regarding the purity of the polymers used in the formation of hydrophilic membranes, it is an object of the present invention to provide a process for obtaining hydrophilic membranes from poly(N-vinyl-2-pyrrolidone) PVP which can better purify the polymer used in the formation of the hydrophilic membrane.

Another object of the present invention is to provide a process as presented above, which allows obtaining larger hydrophilic membranes with better curative properties.

It is a further object of the present invention to provide a process as cited above and which does not imply additional costs to the already known process of obtaining hydrophilic membranes.

These and other objects of the present invention are achieved with a process for obtaining hydrophilic membranes from poly(N-vinyl-2-pyrrolidone) PVP, comprising the steps of: a—obtaining, in a reactor, diethyl maleate from maleic anhydride; b—purifying the diethyl maleate; c—submitting the diethyl maleate to at least two distillation steps, so as to remove therefrom contaminants remaining from the steps of obtaining and purifying the diethyl maleate; d—feeding a load of poly(N-vinyl-2-pyrrolidone)-PVP into a batch reactor; e—adding, to the reactor, a load of the already distilled diethyl maleate, so as to form a mixture having a concentration predetermined as a function of the membrane to be obtained; f—hot treating said mixture, so as to graft the diethyl maleate to the polymer poly(N-vinyl-2-pyrrolidone)-PVP; g—adding to said heated mixture the additional components defined by poly(ethylene glycol)-PEG, agar and water, until reaching 100% by weight of a hydrophilic composition; h—cooling the hydrophilic composition to the ambient temperature; and i—submitting the cooled hydrophilic composition to electron beam irradiation, so as to obtain a hydrogel.

The object of this solution is to produce poly(N-vinyl-2-pyrrolidone)-PVP grafted with diethyl maleate, by the emulsion process, and to produce a hydrophilic membrane based on the polymer obtained, in order to be used as a topic bandage with better properties than those produced only with the poly(N-vinyl-2-pyrrolidone)-PVP, allowing them to be used in bandages with larger sizes, which can be applied to the body of patients with burns of large extensions.

### DESCRIPTION OF THE INVENTION

As already mentioned, the present invention refers to a process for obtaining hydrophilic membranes from poly(N-vinyl-2-pyrrolidone), or simply PVP, grafted with a maleate ester, particularly diethyl maleate, or, in a simplified form, PVPM, for posterior production and processing, by ionizing radiation, of hydrophilic membranes, which are prepared in a final form of use to be employed as topical bandages.

The diethyl maleate is a colorless liquid with boiling point of 220° C.

According to the present invention and as described ahead, the diethyl maleate is bi-distilled before being used to obtain the poly(N-vinyl-2-pyrrolidone) grafted with diethyl maleate, or simply PVPM, used for obtaining the hydrophilic membranes with the adequate properties.

The maleate esters are excellent internal plasticizers for the poly(vinyl acetate), polymethacrylate, polystyrene and other resins. In addition reactions, they are used as intermediaries in many chemical reactions.

The diethyl maleate, which is an ester of the maleic anhydride, is obtained, in a reactor, from maleic anhydride, more particularly from the esterification of the maleic anhydride and the following reagents defined by ethyl alcohol, benzene and sulfuric acid, the ethyl alcohol being provided in a benzene solution, and the sulfuric acid being used as a catalyst.

For this reaction it was used a reflux system in which a mixture of alcohol, particularly ethyl alcohol, maleic anhydride, benzene and sulfuric acid, remained during a reflux time of about 12 h. This reflux step occurs to supply sufficient energy in the adequate time so as to finish the reaction.

After this reflux time of the reagents, it is carried out a step of purifying the formed diethyl maleate. Such purification is obtained in a step of removing the residual acids from the mixture, particularly by neutralizing these residual acids with a sodium bicarbonate solution. After this neutralization, there occurs a posterior step of extracting an organic layer defined as being a layer which contains the diethyl maleate and organic contaminants, by using ethyl ether as the extracting agent. After the step of extracting the organic layer, the diethyl maleate is submitted to a process of distillation, in which the load of diethyl maleate is submitted to at least two distillation steps, particularly consecutive and sequential, so as to remove contaminants remaining from the steps of obtaining and purifying the diethyl maleate, improving the degree of purity of said diethyl maleate, which allows grafting the PVP without interference of contaminants.

Such process allows obtaining the diethyl maleate in the conditions necessary to serve as a reagent in the PVP grafting.

According to the present invention, the diethyl maleate is obtained by providing the following elements:
maleic anhydride, for example, from PETROM—PETROQUÍMICA MOGI DAS CRUZES LTDA, technical degree;
ethyl ether, for example, from MERCK: solvent with molar mass of 70.04 g/mol (H₅C₂)₂O;
ethyl alcohol, for example, from MERCK: solvent with molar mass of 38.32 g/mol C₂H₅OH;
benzene, for example, from MERCK: solvent with molar mass of 378.43 g/mol C₆H₆; and
sulfuric acid

The maleic anhydride is distinguished by its low price and by the excellent properties imparted to the polyester resins. The alkyd resins modified in the substitution of 2% of phthalic anhydride by maleic anhydride present optimal resistance to water and to the alkalies, besides good hardness and color stability.

Its application for obtaining unsaturated polyesters is due to the excellent properties imparted to the polyester resins. In modified alkyd resins, it substitutes the phthalic anhydride, considerably reducing the reaction time, in view of its high reactive power.

At the ambient temperature, the maleic anhydride is a sublimable crystalline solid frequently commercialized under the form of white tablets. Its main physical-chemical characteristics are: melting point, 53° C.; boiling point, 202° C. at atmospheric pressure.

The maleic anhydride is mainly intended for the manufacture of resins, being a little flammable product (flashpoint of the molten product: 102°, in a closed cup). Its vapors can form explosive mixtures with the air in the limits from 1.4% to 7% by volume. The temperature of the molten product should not exceed 80° C.

Table 1 presents the main characteristics of the maleic anhydride.

TABLE 1
Main characteristics of the maleic anhydride.

| PROPERTIES | VALUES |
|---|---|
| Purity (%) | 99.50(*) |
| Solidification point (° C.) | 52.4 |
| Melt color (Pt/Co) | 30 |
| Maleic acid (%) | 1.00 |
| Molar mass (g/mol) | 98.06 |
| Formula | C₄H₂O₃ |
| Density (20° C.) (g/cm³) | 1.48 |
| Appearance (Solid) | White Briquette |

After obtaining the diethyl maleate bi-distilled by the process described above, said constituent is conducted to new process steps for obtaining PVPM, which properties are improved due to the improvement of the quality of the diethyl maleate. The production of the PVPM occurs by addition polymerization, via free radicals, also called chain polymerization. Since it is not a spontaneous reaction, an initiator is necessary.

The addition polymerization occurs in three stages: initiation, propagation and termination.

In the initiation occurs formation of free radicals from the monomer. The propagation is very quick and important, once there occurs growth of the chain in which the formed polymeric radicals attack the monomer molecules successively. The termination is the final phase of chain growth, which starts to predominate from high molar masses by reducing the mobility of the chains for the propagation. When the interruption of the growth is caused by the reaction of two active centers, it is called combination and, when it is caused by transfer of a hydrogen atom from one growth chain to another, saturating an end and creating a double linking in the end of the other chain, it is called disproportionation.

The polymerization conditions must favor the termination by combination, since it results in saturated molecules. On the other hand, the termination by disproportionation should be avoided, once the double linking remaining in the end of the chain is easily attacked.

For the emulsion polymerization of the PVP with diethyl maleate, the PVP and the diethyl maleate were emulsioned in water, containing sodium lauryl sulfate, as the emulsifying agent, so as to stabilize the monomer droplets, in the form of micelles, as well as potassium persulphate as the initiator. The initiator spreads in the micelles containing the monomer and initiates the formation of the polymer.

The PVP grafted with diethyl maleate was obtained in a batch-type reactor, for example, a glass tri-tube of 500 mL with a round bottom, in which there were initially added the PVP (previously solubilized in water) and the diethyl maleate. The proportional quantities of PVP and diethyl maleate loads in the reactor to obtain a load of 0.87 mol of PVPM are, respectively, 1.0 mol of diethyl maleate and 0.5 mol of PVP. After this addition of PVP and diethyl maleate loads, the mixture in the reactor is hot treated, so as to process the reaction.

As described ahead, the present process further presents steps which usually include, after the hot treatment cited above, the hot addition of a load of poly(ethylene glycol), or simply PEG, agar and water, until reaching a value of 100% by mass of a hydrophilic composition. After this step, the obtained hydrophilic composition is cooled to the ambient temperature and submitted to electron beam irradiation, so as to obtain a hydrogel.

In a specific form, after mixing PVP and diethyl maleate in the reactor, it was added a load of surfactant agent, for example, sodium lauryl sulfate, and water to adjust the concentrations indicated for each type of sample. Next, the mixture was heated in a water bath until 50±1° C., being then added an initiator, for example, potassium persulphate, previously dissolved under agitation. The agitation was maintained during the whole reaction.

This process occurs in a reactor (not illustrated) having an outlet in which the following devices were coupled: in a first outlet, a reflux column condenser, in which a safety valve was connected for discharge of the gases; an agitator in a second outlet; and a thermometer in a third outlet.

The reaction time, after adding the initiator, can be of up to 240 minutes, the best properties being obtained for a reaction time, after adding the initiator, of up to 60 minutes. Upon completion of the reaction time, the mixture was cooled to the ambient temperature cited above, which is, preferably, of 25° C. Upon completion of the respective reaction times and the cooling of the mixture to 25° C., the PVPM was extracted from the reagent solution, by precipitation with acetone.

The PEG is a thermoplastic homopolymer (a white resin), obtained by the catalytic polymerization of the ethylene oxide. The resins obtained from the ethylene oxide are offered in a broad variety of molecule masses, being classified as PEG the ones which have average molecular mass inferior to 10⁵.

The PEG is soluble in water and several organic solvents, particularly in chlorinated hydrocarbons but, at high temperatures, the aromatic solvents are the most indicated. At the ambient temperature, it is soluble in water in all the proportions. Its viscosity in aqueous solutions depends on the concentration, on the average molecular mass and markedly on the temperature. The PEG has low degree of toxicity, not causing irritation to the skin. It is used in food packages, in adhesives, cleaning products, detergents, lubricants, paints and hydrogels.

The PEG functions as a plasticizer in the PVPM-based hydrophilic membrane. The plasticizers generally are non-volatile monomer molecules, or polymers of low molar mass, mostly liquid polymers, which, when mixed with polar polymers, or when forming hydrogen bondings, are positioned between the intramolecular bondings and increase the space between the adjacent bondings. These molecules must be polar or form hydrogen bondings. The result of this action is a reduction in the resistance of the intermolecular forces, that is, they reduce the coercive force between the polymeric chains, reducing the mechanical resistance and increasing the flexibility. The function of the plasticizer PEG in the hydrophilic membrane is, therefore, to provide higher flexibility and maintain the hydric concentration, even under low humidity conditions (due to the formation of hydrogen bondings).

The PEG used herein is the ATPEG 300 from OXITENO, with the characteristics presented in Table 2.

TABLE 2
Main characteristics of the poly(ethylene glycol)
ATPEG 300, from OXITENO.

| PROPERTIES | VALUES |
|---|---|
| Physical State | Limpid liquid |
| Tg (° C.) | −35 |
| Density (g/cm³) | 1.13 |
| Weighted Average Molar Mass (Mw) | 285 |
| Numeric Average Molar Mass (Mn) | 315 |
| Flashpoint (° C.) | 169 |
| Acidity Index (mg KOH/g) | 0.5 |
| Ash content (%) | 0.1 |
| pH (25° C.) (aqueous solution 5%) | 4.5-7.5 |
| Hydroxyl Index (mg KOH/g) | 356-394 |
| K.F. Water (%) | 1% |

The agar is a product similar to others which form the gelatine, being mainly produced from the red algae Gelidium and Gracilaria. It is used as a solidification factor in bacteriological cultures, as well as in cosmetics, medicinal and dentifrice products, as a clarifying agent in the production of wines and in food. The agar is prepared by boiling, purifying and drying the algae, being a solid, translucent and amorphous product, and it can present the form of powder or granules. Although the agar is insoluble in cold water, it can absorb up to 20 times its mass in water. The agar is rapidly dissolved in boiling water, forming a liquid above 42° C. and solidifies below 37° C., forming a firm gel in diluted solutions. The presence of the agar in the formation of the PVP-based hydrophilic membrane allows maintaining the physical form of the membrane, before cross-linking the PVP.

The agar used is the technical agar N^{o}3, under code L.13 (according to the specifications of the United States pharmacopeia-APhA.), from OXOID (extracted from the red algae agarophytes). It presents high mineral content, which is an obstacle for microorganism growth.

The main characteristics of the technical agar N^{o}3, under code L.13, from OXOID, are showed in Table 3.

The agar L.13 should be maintained in duly closed recipients, allowing it to be stored under normal conditions.

TABLE 3
Main characteristics of the technical agar
N° 3, L.13, from OXOID.

| PROPERTIES | VALUES |
|---|---|
| Appearance | Clear Powder |
| Humidity (%) | 12.0 |
| Ashes (%) | 4.2 |
| Ashes insoluble in acid (%) | <0.1 |
| SO4 (%) | 1.7 |
| Total of Nytrogen (%) | 0.1 |
| Ca (ppm) | 400 |
| Mg (ppm) | 100 |
| Fe (ppm) | Not detected |

According to the present solution, for obtaining the hydrogels there were employed, in a more specific form:
(a) For the formation of the PVP-based membrane: a load of polymer PVP with an average molar mass of 1.2×10⁶, supplied by GAF Co.; a load of PEG with molar mass of 400, from Oxiteno do Brasil; and a load of agar from OXOID, code L.13.
(b) For the formation of the PVPM-based membrane: the polymer PVP with diethyl maleate obtained from the reaction of the polymer PVP with an average molar mass of 1.2×10⁶, supplied by GAF Co. with the synthesized diethyl maleate; PEG with a molar mass of 400, from Oxiteno do Brasil; agar from OXOID, code L.13.

With the object of obtaining a new hydrogel, it was synthesized a mixture of PVP grafted with diethyl maleate by the emulsion process, by adding the diethyl maleate in an PVP aqueous solution, using potassium persulphate as the initiator and sodium lauryl sulfate as the surfactant agent. After this reaction, the obtained product was characterized by means of thermal analysis and absorption spectroscopy in the infrared region. The results indicated the formation of the grafted polymer. With the obtained polymer there were produced hydrogels by ionizing radiation coming from an electron accelerator. Hydrogels were prepared with concentrations of 8% and 10% of the polymer obtained by emulsion and they were submitted to an irradiation dose of about 25 kGy. PVP-based hydrogels obtained by ionizing radiation are sterile and biocompatible and can be used as topical bandages.

There were prepared three types of hydrogels constituted by: 10% of PVP, 3% of PEG and 0.8% of agar (traditional membrane); 10% of PVP, 10% of diethyl maleate, 3% of PEG and 0.8% of agar; 10% of PVP grafted with diethyl maleate, 3% of PEG and 0.8% of agar.

The reagents, previously dissolved in water, were hot mixed and the concentration of the components in the final solution was adjusted by adding water in quantities sufficient for reaching 100% by weight. The different mixtures were poured into duly leveled molds, so as to obtain membranes with 3 mm of thickness. By cooling it was obtained the thermally reversible physical gel, resulting from the presence of agar. The molds containing the physical gel, adequately packaged with duly sealed polythene film, with thickness of approximately 0.1 mm, as recommended for bandages to be used directly on the skin, were submitted to electron beam irradiation, coming from an electron accelerator of the “Dynamitron”-type from “Radiation Dynamics”, with energy of about 1.5 MeV and dose rate of 11.3 kGy/s, in the dose of 25 kGy.

With the process described above, it is obtained PVP grafted with diethyl maleate and, from this, hydrophilic membranes based on PVP grafted with diethyl maleate. The membranes obtained with PVP grafted with diethyl maleate have better properties than the ones obtained with PVP, present neutral pH, which is adequate for applications in topical bandages; and are more transparent than the hydrophilic membranes obtained with non-grafted PVP.

From the results obtained in the tests for determining conversion and average viscosimetric molecular mass, it was verified that the conditions chosen for the synthesis of the PVPM (1.0 hour) are favorable, since they presented good results both in conversion percentage and in average viscosimetric molecular mass.

1. A process for obtaining hydrophilic membranes from poly(N-vinyl-2-pyrrolidone) PVP, comprising the steps of:
a—obtaining, in a reactor, diethyl maleate from maleic anhydride; and
b—purifying the diethyl maleate, said process being characterized in that it further comprises the steps of:
c—submitting the diethyl maleate to at least two distillation steps, so as to remove, therefrom, contaminants remaining from the steps of obtaining and purifying the diethyl maleate;
d—feeding a load of poly(N-vinyl-2-pyrrolidone)-PVP into a batch reactor;
e—adding, to the reactor, a load of the already distilled diethyl maleate, so as to form a mixture having a concentration predetermined as a function of the membrane to be obtained;
f—hot treating said mixture, so as to graft the diethyl maleate to the polymer poly(N-vinyl-2-pyrrolidone)-PVP;
g—adding to said heated mixture the additional components defined by poly(ethylene glycol)—PEG, agar and water, until reaching 100% by weight, of a hydrophilic composition;
h—cooling the hydrophilic composition to the ambient temperature; and
i—submitting the cooled hydrophilic composition to electron beam irradiation, so as to obtain a hydrogel.

2. The process, as set forth in claim 1, characterized in that the step of obtaining the diethyl maleate is carried out with the following reagents added to the maleic anhydride: ethyl alcohol; benzene; and sulfuric acid.

3. The process, as set forth in claim 2, characterized in that it includes, after obtaining the diethyl maleate, the additional steps of:
a1-maintaining the reagents in reflux by a period of time sufficient to terminate the reaction;
a2-purifying the diethyl maleate, after the reflux time of the reagents;
a3-removing residual acids from the mixture; and
a4-extracting an organic layer containing diethyl maleate and organic contaminants;

4. The process, as set forth in claim 3, characterized in that the step of removing residual acids is obtained with a mixture of sodium bicarbonate.

5. The process, as set forth in claim 3, characterized in that the extraction of the organic layer is made with ethyl ether.

6. The process, as set forth in claim 5, characterized in that the steps of distillation of the diethyl maleate are carried out after the step of extracting the organic layer.

7. The process, as set forth in claim 1, characterized in that it comprises, previously to the step of feeding the poly(N-vinyl-2-pyrrolidone)-PVP to the reactor, an additional step of solubilizing, in water, the load of poly(N-vinyl-2-pyrrolidone)-PVP.

8. The process, as set forth in claim 1, characterized in that it comprises, after the step of adding PEG, agar and water to the mixture, the steps of: adding sodium lauryl sulfate; heating the mixture in the water bath; adding an initiator previously dissolved under agitation; cooling the mixture, after a certain time of the initiator addition has elapsed, and, after the cooling time has elapsed, the polymer poly(N-vinyl-2-pyrrolidone)-PVP grafted with diethyl maleate is separated from the mixture.

9. The process, as set forth in claim 8, characterized in that the addition time of the initiator is of up to 240 minutes.

10. The process, as set forth in claim 9, characterized in that the reaction time after the addition of the initiator is of up to 60 minutes.

11. The process, as set forth in claim 10, characterized in that the initiator is potassium persulphate.

12. The process, as set forth in claim 1, characterized in that the mixture is cooled to an ambient temperature of 25° C.

13. The process, as set forth in claim 8, characterized in that the heating of the mixture in the water bath is in a temperature of up to 50° C.

14. The process, as set forth in claim 3, characterized in that the reflux time is of up to 12 hours.

15. The process, as set forth in claim 1, characterized in that the distillation steps are consecutive and sequential.

16. The process, as set forth in claim 1, characterized in that the hydrophilic composition comprises 10% of poly(N-vinyl-2-pyrrolidone)-PVP; 10% of diethyl maleate; 3% of poly(ethylene glycol)-PEG; and 0.8% de agar.

17. The process, as set forth in claim 1, characterized in that the energy range of the electron beam is of about 1.5 MeV and the dose rate is of 11.3 kGy/s in the dose of 25 kGy.
